(19) United States
(12) Patent Application Publication
(10) Pub. No.: US 2010/0060838 A1
(43) Pub. Date: Mar. 11, 2010

(54) LIQUID CRYSTAL DISPLAY AND METHOD THEREOF

(75) Inventors: Hoon KIM, Ansan-si (KR); Jae-Jin LYU, Yongin-si (KR); Ji-Won SOHN, Seoul (KR); Myeong-Ha KYE, Seoul (KR); Min-Jae KIM, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/508,200

(22) Filed: Jul. 23, 2009

(30) Foreign Application Priority Data
Sep. 9, 2008 (KR) 10-2008-0088877

(51) Int. Cl. G02F 1/1343

(52) U.S. Cl. 349/141

(57) ABSTRACT

A liquid crystal display (“LCD”) includes first and second substrates facing each other, a plurality of pixel electrodes arranged in a matrix shape on the first substrate and including a stem and a plurality of minute branches obliquely extending from the stem, a common electrode facing the plurality of pixel electrodes, and a liquid crystal layer interposed between the first substrate and the second substrate and including a plurality of liquid crystal molecules, wherein the pixel electrodes are classified into a plurality of sub-regions according to a length direction of the minute branches, and the minute branches are protruded at edges of the sub-regions.

This application claims priority to Korean Patent Application No. 10-2008-0088877, filed on Sep. 9, 2008, and all the benefits accruing therefrom under 35 U.S.C. §119, the contents of which in its entirety are herein incorporated by reference.

### BACKGROUND OF THE INVENTION

(a) Field of the Invention

The present invention relates to a liquid crystal display (“LCD”) and method thereof. More particularly, the present invention relates to an LCD having an improved response speed and a method of improving response speed of the LCD.

(b) Description of the Related Art

A liquid crystal display (“LCD”) is one of the most widely used flat panel displays (“FPD”), and it is composed of two display panels on which field generating electrodes are formed, and a liquid crystal layer interposed between the two display panels. A voltage is applied to the field generating electrodes to generate an electric field on the liquid crystal layer, and the orientation of liquid crystal molecules of the liquid crystal layer is determined and the polarization of incident light is controlled through the generated electric field to display an image.

Among the LCDs, a vertical alignment (“VA”) mode LCD, which aligns LC molecules such that the long axes of the LC molecules are perpendicular to the panels in the absence of an electric field, has a high contrast ratio and wide reference viewing angle.

In the VA mode LCD, the wide reference viewing angle can be realized by forming a plurality of domains including LC molecules with different alignment directions in one pixel.

To form the plurality of domains in one pixel, there is a method of forming cutouts such as minute slits in the field generating electrodes or forming protrusions on the field generating electrodes. In this method, the plurality of domains may be formed by aligning the liquid crystal molecules perpendicular with respect to a fringe field generated between the edges of the cutout or protrusion, and the field generating electrodes facing the edges.

However, when the liquid crystal in the VA mode LCD is applied with the electric field of the perpendicular direction in the vertical aligned state, the inclination direction of the liquid crystal is random such that the response speed in which the LC molecules are aligned in one direction to form the domain is slow.

Accordingly, the liquid crystal may be pre-tilted to improve the response speed of the VA mode LCD.

### BRIEF SUMMARY OF THE INVENTION

It has been determined herein, according to the present invention, that the conventional VA mode liquid crystal display (“LCD”) having pre-tilted liquid crystal to improve the response speed must increase the number of processes for improving the response speed.

The present invention improves response speed without additional processes.

The present invention also provides a method of improving response speed in an LCD without additional processes.

A liquid crystal display (“LCD”) according to the present invention includes a first substrate and a second substrate facing each other, a plurality of pixel electrodes arranged in a matrix shape on the first substrate and each including a stem and a plurality of minute branches obliquely extending from the stem, a common electrode facing the plurality of pixel electrodes, and a liquid crystal layer interposed between the first substrate and the second substrate and including a plurality of liquid crystal molecules, wherein the pixel electrodes are classified into a plurality of sub-regions according to a length direction of the minute branches, and the minute branches are protruded at edges of the sub-regions.

The LCD may further include a passivation layer disposed between the first substrate and the pixel electrodes, and the passivation layer includes a first protrusion corresponding to the edges of the sub-regions.

One end of each of the minute branches may overlap the first protrusion, and the stem connected to the minute branches may overlap the first protrusion.

The passivation layer may be made of an organic material having a low dielectric ratio.

The LCD may further include a gate line disposed on the first substrate and disposed under the pixel electrode, a data line intersecting the gate line, and a thin film transistor (“TFT”) connected to the gate line, the data line, and the pixel electrode, and the one end of each of the minute branches may overlap the data line.

The thickness of the first protrusion may be less than about 1/10 of the cell gap between an upper layer having the second substrate and a lower layer having the first substrate, and may preferably be less than about 0.5 μm.

The cross-section of the first protrusion may be trapezoidal.

The liquid crystal molecules close to the first protrusion among the liquid crystal molecules of the liquid crystal layer may be perpendicular to a side surface of the first protrusion, and liquid crystal molecules corresponding to a central region of the minute branches among the liquid crystal molecules of the liquid crystal layer may be perpendicular to the substrate.

The LCD may further include an overcoat formed between the common electrode and the second substrate, and the overcoat may include a second protrusion corresponding to an area between first protrusions.

The common electrode may form a convexo-concave surface according to the second protrusion.

The thickness of the second protrusion may be less than about 1/10 of the cell gap between an upper layer having the second substrate and a lower layer having the first substrate, and the thickness of the second protrusion may be less than about 0.5 μm.

The cross-section of the second protrusion may be trapezoidal.

The minute branches of neighboring sub-regions may be symmetrical with respect to the stem of the sub-regions, and the minute branches of two neighboring sub-regions may be orthogonal to each other.

In an alternative exemplary embodiment, a first groove may be disposed according to a length direction of the minute branches between the minute branches.

According to the present invention, the response speed of the LCD may be improved without additional processes.

### BRIEF DESCRIPTION OF THE DRAWINGS

The above and other features and advantages of the present invention will become more apparent by describing exemplary embodiments thereof with reference to the accompanying drawings, in which:

FIG. 1 is a layout view of an exemplary liquid crystal display (“LCD”) according to an exemplary embodiment of the present invention;

FIG. 2 is a cross-sectional view taken along line II-II of FIG. 1;

FIG. 3 is a cross-sectional view taken along line III-III of FIG. 1;

FIG. 4 is a graph showing transmittances according to response time of an exemplary LCD according to an exemplary embodiment of the present invention and an LCD without protrusions;

FIG. 5 is a graph showing an azimuth angle of a liquid crystal molecule in an exemplary LCD according to an exemplary embodiment of the present invention and an LCD according to a comparative example;

FIG. 6 is a graph showing response time and transmittance of a liquid crystal molecule in an exemplary LCD according to an exemplary embodiment of the present invention and an LCD according to a comparative example;

FIG. 7 is a cross-sectional view of an exemplary LCD according to another exemplary embodiment of the present invention, taken along line II-II of FIG. 1;

FIG. 8 is a layout view of an exemplary LCD according to an exemplary embodiment of the present invention;

FIG. 9 is a cross-sectional view taken along line IX-IX of FIG. 8;

FIG. 10 is a layout view of the exemplary LCD shown in FIG. 8 except for the pixel electrode;

FIG. 11 is a layout view of the exemplary pixel electrode in the exemplary LCD shown in FIG. 8; and,

FIG. 12 is a cross-sectional view of an exemplary LCD according to another exemplary embodiment of the present invention, taken along line II-II of FIG. 1.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

### First Exemplary Embodiment

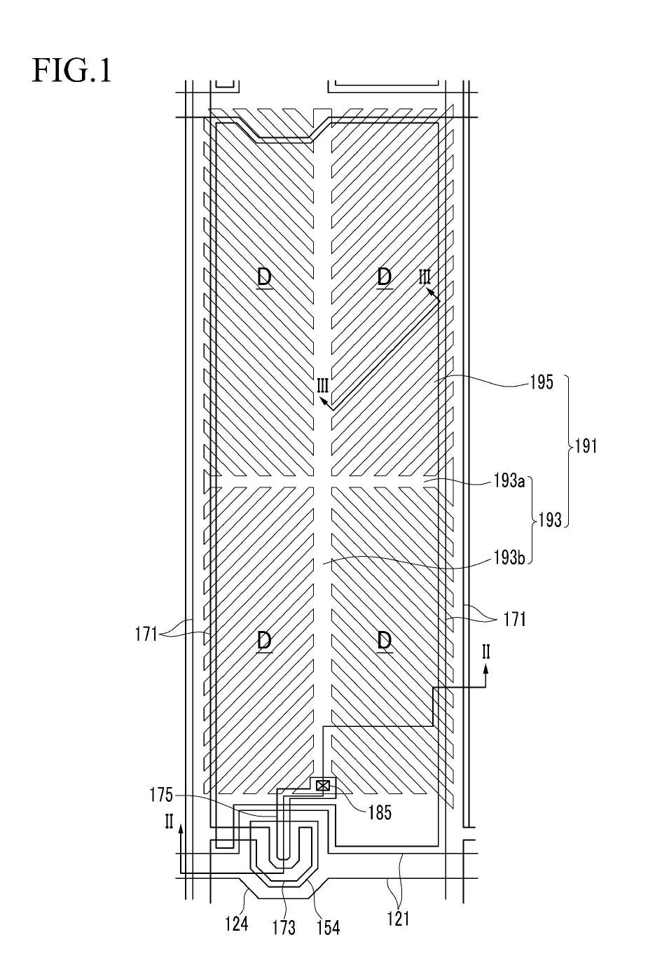

A liquid crystal display (“LCD”) according to an exemplary embodiment of the present invention will be described with reference to FIG. 1 to FIG. 3.

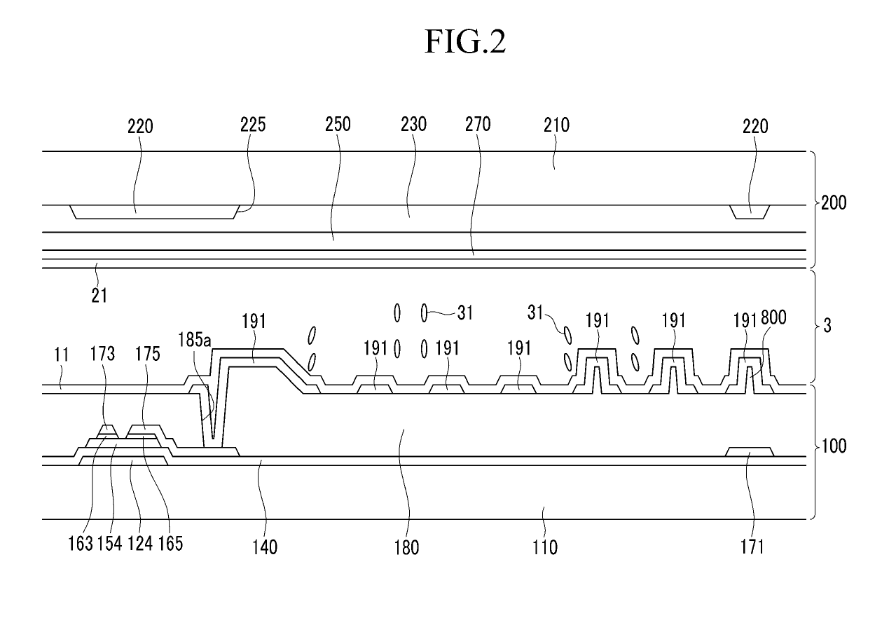

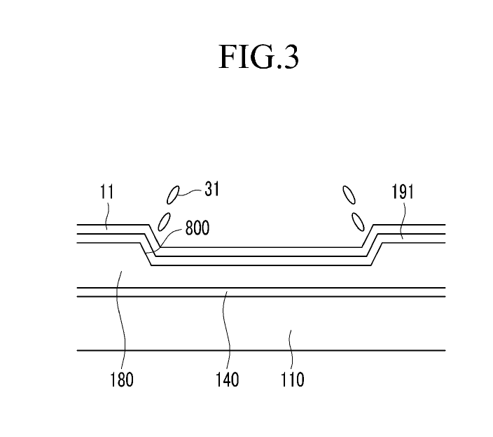

FIG. 1 is a layout view of an exemplary LCD according to an exemplary embodiment of the present invention, FIG. 2 is a cross-sectional view taken along line II-II of FIG. 1, and FIG. 3 is a cross-sectional view taken along line III-III of FIG. 1.

Referring to FIG. 1 to FIG. 3, an LCD according to an exemplary embodiment of the present invention includes a lower panel 100 and an upper panel 200 facing each other, and a liquid crystal layer 3 interposed between the two display panels 100 and 200.

Firstly, the lower panel 100 will be described.

A plurality of gate lines 121 including a plurality of gate electrodes 124 protruding upward are formed, hereinafter disposed, on an insulating substrate 110. The gate lines 121 transmit gate signals and are substantially extended in the transverse direction, such as a first direction.

A gate insulating layer 140 is disposed on the gate lines 121, and a plurality of semiconductor islands 154 preferably made of amorphous or crystallized silicon are disposed on the gate insulating layer 140.

A plurality of pairs of ohmic contacts 163 and 165 are disposed on the semiconductor islands 154. The ohmic contacts 163 and 165 may include a material such as n+hydrogenated amorphous silicon (“a-Si”) in which an n-type impurity is doped with a high concentration, or of silicide.

A plurality of data lines 171 and a plurality of drain electrodes 175 are disposed on the ohmic contacts 163 and 165 and the gate insulating layer 140.

The data lines 171 transmit data signals, extend substantially in the longitudinal direction, a second direction substantially perpendicular to the first direction, and cross the gate lines 121. Each data line 171 includes a plurality of source electrodes 173 extending toward the gate electrodes 124 and curved with a “U” shape.

One end of each drain electrode 175 is enclosed by a source electrode 173, and the other end thereof has a wide area for connection with another layer.

A gate electrode 124, a source electrode 173, and a drain electrode 175 respectively form a thin film transistor (“TFT”) along with a semiconductor island 154, and a channel of the TFT is disposed on the semiconductor island 154 between the source electrode 173 and the drain electrode 175.

The ohmic contacts 163 are interposed only between the underlying semiconductor islands 154, and the overlying data lines 171 and drain electrodes 175, and reduce contact resistance between them. The semiconductor islands 154 have a portion that is exposed without being covered by the data lines 171 and the drain electrodes 175, and a portion between the source electrodes 173 and the drain electrodes 175.

A passivation layer 180 preferably made of inorganic insulator or an organic insulator is disposed on the data lines 171, the drain electrodes 175, and the exposed semiconductor islands 154. When the passivation layer 180 is made of the organic insulator, a lower layer may be made of a soft material having a low dielectric ratio and an upper layer may be made of a solid material having a higher dielectric ratio than that of the lower layer.

The passivation layer 180 has a plurality of contact holes 185 exposing the drain electrodes 175. The passivation layer 180 includes protrusions 800 that are protruded compared with another portion of the passivation layer 180 and the protrusions 800 are integrated with the passivation layer 180, however they may be formed with another layer.

The thickness of the protrusions 800 may be less than about 1/10 of the cell gap, and preferably less than about 0.5 μm. The cell gap is the distance between the upper panel 200 and the lower panel 100. For example, when the cell gap is in the range of about 3.2 to about 4.0 μm, the thickness of the protrusions 800 is less than about 0.32 to about 0.4 μm. The protrusions 800 may have a trapezoidal cross-section.

When the passivation layer 180 includes the organic insulating material having the low dielectric ratio, a pixel electrode 191 that will be described later may overlap the data lines 171 such that the protrusions 800 are disposed to be overlapped with the data lines 171. If the protrusions 800 are disposed on the data lines 171, the passivation layer 180 is protruded by the data lines 171 such that the thickness of the protrusions 800 is increased by the thickness of the data lines 171, thereby obtaining the same effects even if the thickness of the protrusions 800 is reduced by the thickness of the data lines 171.

When integrally forming the protrusions 800, as in an exemplary embodiment of the present invention, a photosensitive film pattern having different thicknesses depending on positions is disposed on an insulating layer for the passivation layer 180 by using halftone exposure using slits, and the passivation layer 180 may be formed by using the photosensitive film pattern as a mask. In an alternative exemplary embodiment the passivation layer 180 may be directly made of a photosensitive material, and halftone exposed and developed.

A plurality of pixel electrodes 191 preferably made of a transparent conductive material such as indium tin oxide (“ITO”) or indium zinc oxide (“IZO”), or a reflective metal such as aluminum (Al), silver (Ag), chromium (Cr), or alloys thereof, are disposed on the passivation layer 180.

The pixel electrodes 191 are connected to the drain electrodes 175 through the contact holes 185 and receive data voltages from the drain electrodes 175.

The pixel electrodes 191 may have a quadrangular shape, and include a stem 193 and a plurality of minute branches 195.

In detail, the stem 193 includes a transverse stem 193a, extending substantially in the first direction, and a longitudinal stem 193b, extending substantially in the second direction, crossing the pixel in the transverse and the longitudinal directions, respectively, and the transverse stem 193a and the longitudinal stem 193b cross each other. The pixel electrodes 191 are divided into a plurality of sub-regions D by the stem 193.

The minute branches 195 are disposed in the sub-regions D, extend obliquely with respect to the transverse stem 193a and the longitudinal stem 193b, and form an angle of about 45 degrees with the gate line 121.

The minute branches 195 of the neighboring sub-regions D are symmetrical with reference to the transverse stem 193a or the longitudinal stem 193b, and may be crossed.

The width of the minute branches 195 may be in the range of about 2.5 μm to about 5.0 μm, and the interval between the neighboring minute branches 195 in the sub-regions D may be in the range of about 2.5 μm to about 5.0 μm.

The protrusions 800 of the passivation layer 180 correspond to the edges of the sub-regions D, and the end portions of the minute branches 195 overlap the protrusions 800. Thus, the end portions of the minute branches 195 protrude towards the upper panel 200.

That is, the protrusions 800 overlap with the end portions of the stems 193 of the pixel electrode 191 and the minute branches 195 disposed on the edges of the sub-regions D. Therefore, while the pixel electrode 191 may be formed from a layer of the LCD having a substantially constant thickness, select portions of the pixel electrode 191 protrude towards the upper panel 200.

An alignment layer 11 is disposed on the pixel electrode 191.

Next, the upper panel 200 will be described.

A light blocking member 220 is disposed on a substrate 210. The light blocking member 220 prevents light leakage between the pixel electrodes 191 and includes openings 225 defining the regions facing the pixel electrodes 191.

A plurality of color filters 230 are disposed on the substrate 210 and the light blocking member 220. The color filters 230 are mostly existent within the regions defined by the light blocking member 220, however they may overlap the light blocking member 220. The color filters 230 may longitudinally extend along the columns of pixel electrodes 191 in the vertical direction. Each of the color filters 230 may display one color in a set of colors, such as three primary colors, such as red, green, and blue.

An overcoat 250 is disposed on the color filter 230 and the light blocking member 220, and a common electrode 270 preferably made of a transparent conductor such as ITO or IZO is disposed on the whole surface, or substantially an entire surface, of the overcoat 250. In an alternative exemplary embodiment, the overcoat 250 may be omitted if necessary.

An alignment layer 21 is coated or otherwise disposed on the common electrode 270.

The two alignment layers 11 and 21 may be vertical alignment layers. A polarizer (not shown) may be provided on the outer surface of the display panels 100 and 200. The transmissive axes of two polarizers (not shown) are crossed and form an angle of about 45 degrees with the minute branches 195.

The liquid crystal layer 3 between the lower panel 100 and the upper panel 200 has negative dielectric anisotropy, and may be oriented such that the major axes of the liquid crystal molecules 31 of the liquid crystal layer 3 are almost perpendicular to the surfaces of the two display panels 100 and 200 when no electric field is applied to the pixel electrodes 191 and common electrode 270.

The pixel electrodes 191, to which the data voltage is applied, generate an electric field together with the common electrode 270 of the upper panel 200 that receives the common voltage. Thus, liquid crystal molecules 31 of the liquid crystal layer 3 change directions so that the major axes thereof become perpendicular to the direction of the electric field in response to the electric field. The change degree of the polarization of the light that is incident to the liquid crystal layer 3 is changed according to the inclination degree of the liquid crystal molecules 31, and this change of polarization appears as a change of transmittance by the polarizer, thereby displaying images on the LCD.

Here, the edges of the minute branches 195 distort the electric field to make the horizontal components perpendicular to the edges of the minute branches 195, and the inclination direction of the liquid crystal molecules 31 is determined to be the direction determined by the horizontal components. Accordingly, the liquid crystal molecules 31 initially tend to incline in the direction perpendicular to the edges of the minute branches 195. However, the directions of the horizontal components of the electric field by the neighboring minute branches 195 are opposite to each other and the intervals between the minute branches 195 are narrow such that the liquid crystal molecules 31 that tend to arrange in the opposite directions are tilted in the direction parallel to the length direction of the minute branches 195.

Accordingly, if the liquid crystal molecules 31 are initially not pre-tilted in the length direction of the minute branches 195, the liquid crystal molecules 31 are tilted in the length direction of the minute branches 195 through two steps.

However, in the present exemplary embodiment, the liquid crystal molecules 31 are already pre-tilted by the protrusions 800 such that the liquid crystal molecules 31 are not tilted through two steps, but are tilted in the direction parallel to the length direction of the minute branches 195 through one step.

That is, in the present exemplary embodiment, the liquid crystal molecules 31 are inclined to have the pre-tilt angle in the direction parallel to the minute branches 195 due to the side surface of the protrusions 800. If the electric field is applied, the liquid crystal molecules 31 that are disposed on the end portions of the minute branches 195 start the alignment and are aligned parallel to the minute branches 195. Here, the inclination direction of the liquid crystal molecules 31 is already determined by the pre-tilt such that they are inclined in the pre-tilt direction parallel to the length direction of the minute branches 195 through one step, not two steps. Accordingly, the response speed of the LCD is increased.

In an exemplary embodiment of the present invention, the length directions in which the minute branches 195 are extended in one pixel PX are all four directions, such as about 45 degrees, about −45 degrees, about −135 degrees, and about 135 degrees, such that the inclined directions of the liquid crystal molecules 31 are all four directions. Therefore, the viewing angle of the LCD is widened by varying the inclined directions of the liquid crystal molecules 31.

These results may be confirmed with reference to graphs as described below.

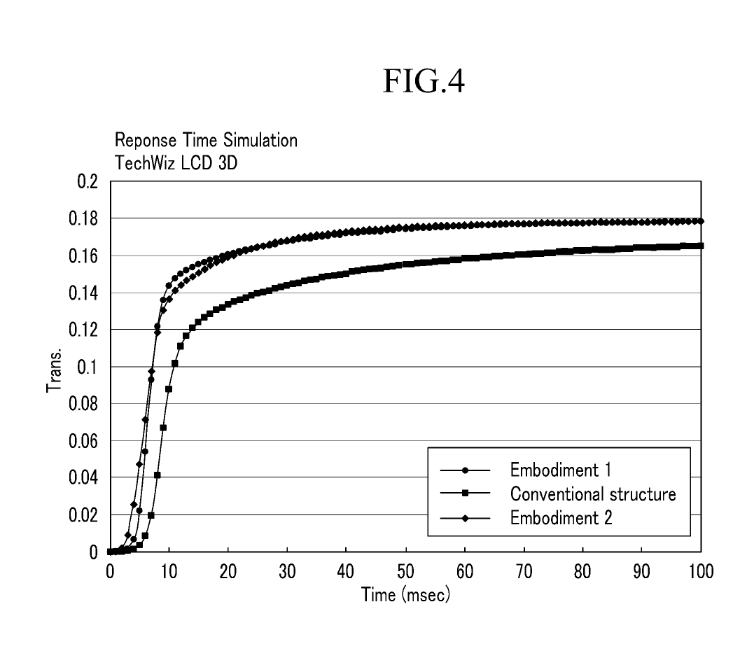

FIG. 4 is a graph showing transmittances according to response time of an exemplary LCD according to an exemplary embodiment of the present invention and an LCD without protrusions 800.

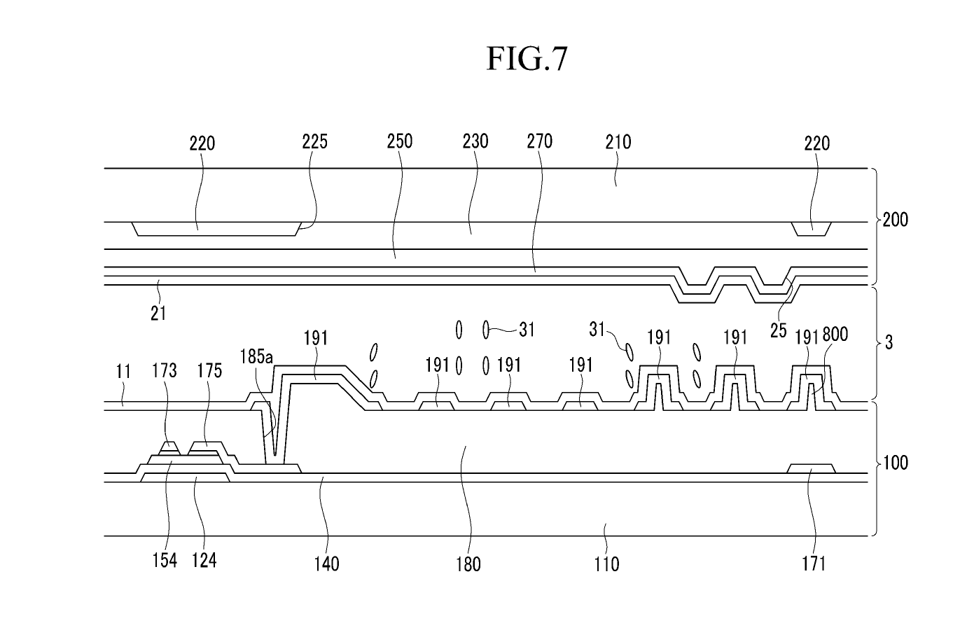

Referring to FIG. 4, when the speed is 10 msec, the transmittance of the LCD according to an exemplary embodiment of the present invention (Embodiment 1) is about 0.15, and that of the conventional art is about 0.09. Also, when the speed is 10 msec, the transmittance of the present invention has a higher value than the case (the comparative example, identified as conventional structure) in which the protrusions 800 are not formed. Also, the time representing the value of the transmittance of about 1.0 is fast in the present invention compared with the conventional art. The case identified as Embodiment 2 will be described further below with respect to FIG. 7.

Accordingly, in the LCD according to an exemplary embodiment of the present invention, the response speed is improved as well as the transmittance, compared with the comparative example.

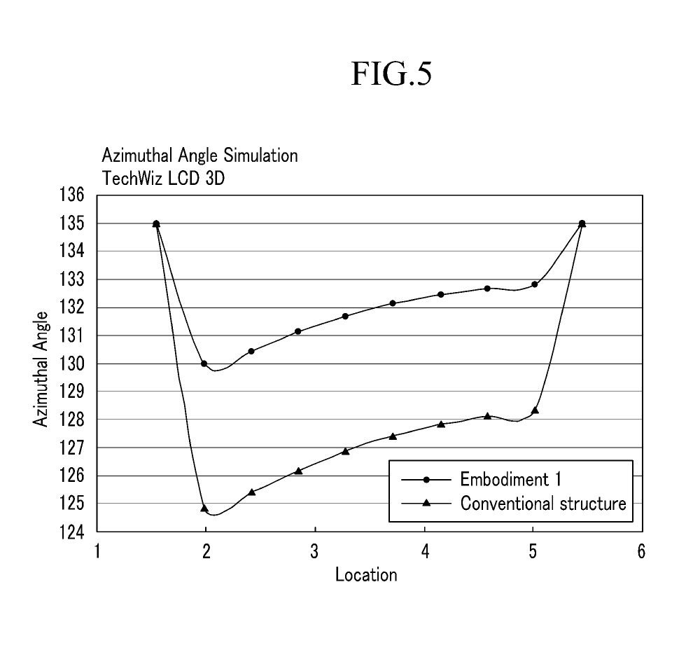

FIG. 5 is a graph showing an azimuth angle of a liquid crystal molecule in an exemplary LCD according to an exemplary embodiment of the present invention and an exemplary LCD according to a comparative example.

Referring to FIG. 5, an azimuth angle of liquid crystal molecules according to an exemplary embodiment of the present invention is mostly in the range of 130-135 degrees, parallel to the minute branches 195, however an azimuth angle of the liquid crystal molecules of the LCD according to comparative example is in the range of 125-135 degrees, the deviation thereof is large, and the most thereof are at 130 degrees.

Accordingly, in an exemplary embodiment of the present invention, the liquid crystal molecules 31 are mostly aligned parallel to the minute branches 195, thereby improving the transmittance.

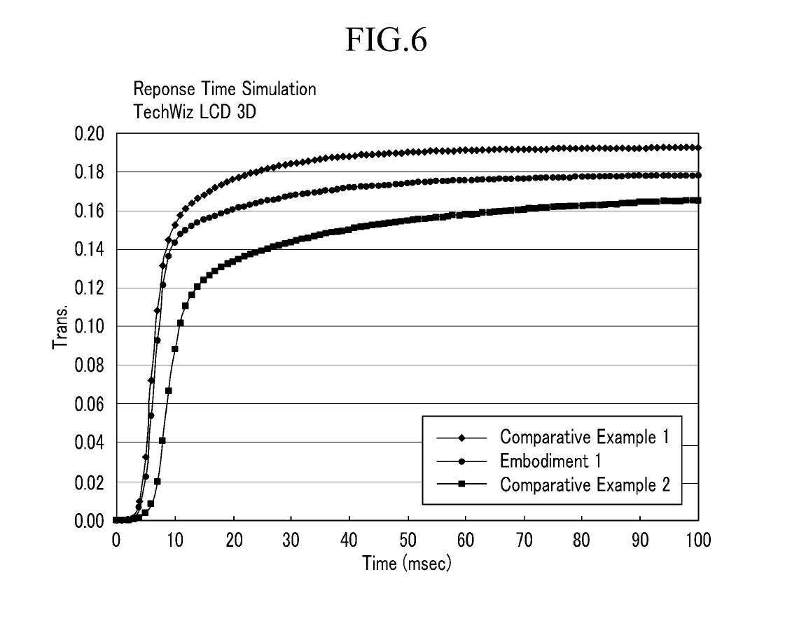

FIG. 6 is a graph showing response time and transmittance of liquid crystal molecules in an exemplary LCD according to an exemplary embodiment of the present invention and an LCD according to a comparative example.

In FIG. 6, Comparative Example 1 is a case in which the liquid crystal molecules are pre-tilted by using UV hardener as in an exemplary embodiment of the present invention, and Comparative Example 2 is a case in which UV hardener is not added and the liquid crystal molecules are not pre-tilted.

Referring to FIG. 6, transmittance and response speed of an LCD according to an exemplary embodiment of the present invention are improved with respect to Comparative Example 2 such that the curve of the present invention is close to that of Comparative Example 1 as though the curve of the present invention smaller than that of Comparative Example 1.

That is, as an exemplary embodiment of the present invention, the protrusions overlapping with the edges of the pixel electrodes are formed for the liquid crystal molecules to have the pre-tilt angle such that transmittance and response speed that are improved compared with Comparative Example 2 may be obtained without the addition of the UV hardener used in Comparative Example 1.

Accordingly, the process for exposing the UV hardener is not necessary in the present invention, thereby simplifying the manufacturing process.

### Second Exemplary Embodiment

FIG. 7 is a cross-sectional view of an exemplary LCD according to another exemplary embodiment of the present invention, taken along line II-II of FIG. 1.

The layered structure of the LCD according to the present exemplary embodiment and the descriptions thereof are substantially the same as those of the previous exemplary embodiment shown in FIG. 1 to FIG. 3, so description of the same elements is omitted and only different elements from those of the previous exemplary embodiment will be described in the current exemplary embodiment of the present invention. The lower panel 100 is the same as the lower panel 100 shown in FIG. 2, such that only the upper panel 200 will be described.

In the upper panel 200 of FIG. 7, a light blocking member 220 having openings 225 is disposed on a substrate 210. Also, a plurality of color filters 230 are disposed on the substrate 210 and the light blocking member 220.

An overcoat 250 is disposed on the color filters 230 and the light blocking member 220, and a common electrode 270 made of the transparent conductor such as ITO and IZO is disposed on the whole surface, or substantially the whole surface, of the overcoat 250. An alignment layer 21 is disposed on the common electrode 270.

However, the overcoat 250 of FIG. 7 has protrusions 25 and the protrusions 25 correspond to the portions between the neighboring minute branches 195 of the lower panel 100.

Referring to FIG. 4, the transmittance and the response speed of the LCD according to an exemplary embodiment of the present invention (Exemplary Embodiment 2) is improved compared with the comparative example (conventional structure) such that the transmittance and the response speed may have almost the same value as that of the LCD according to the exemplary embodiment (Exemplary Embodiment 1) of FIG. 1.

### Third Exemplary Embodiment

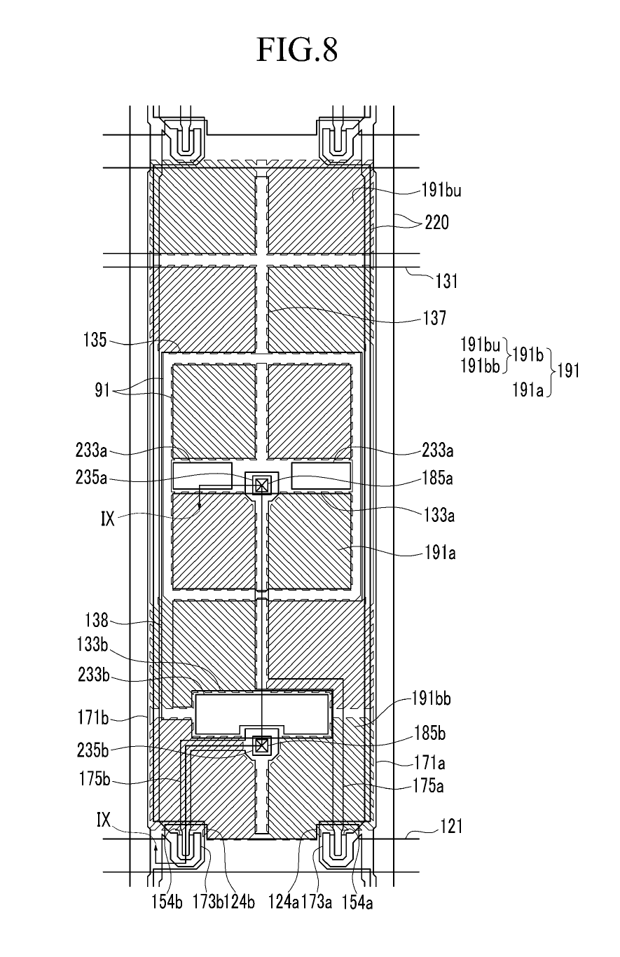

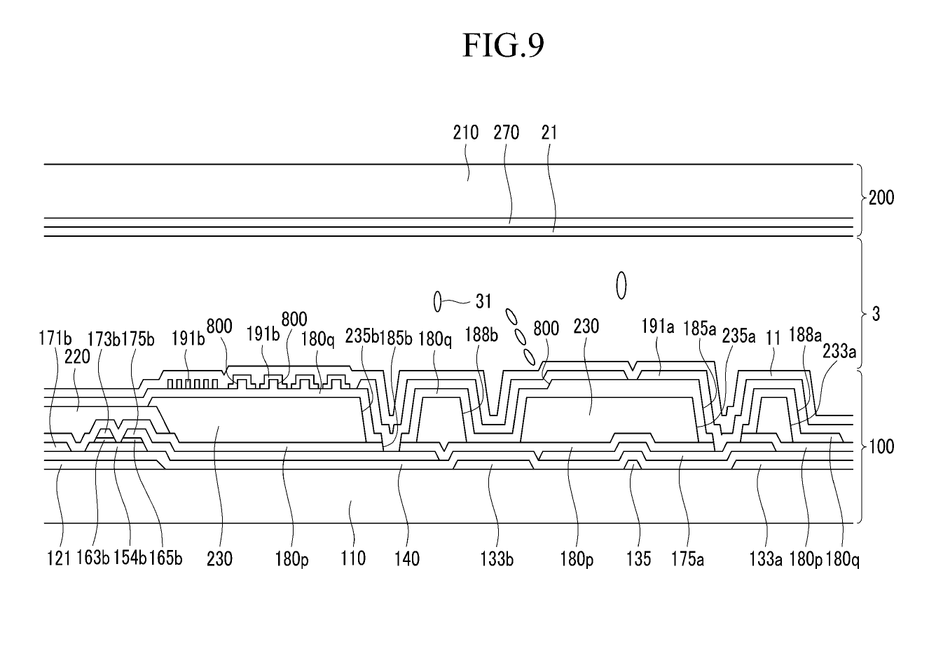

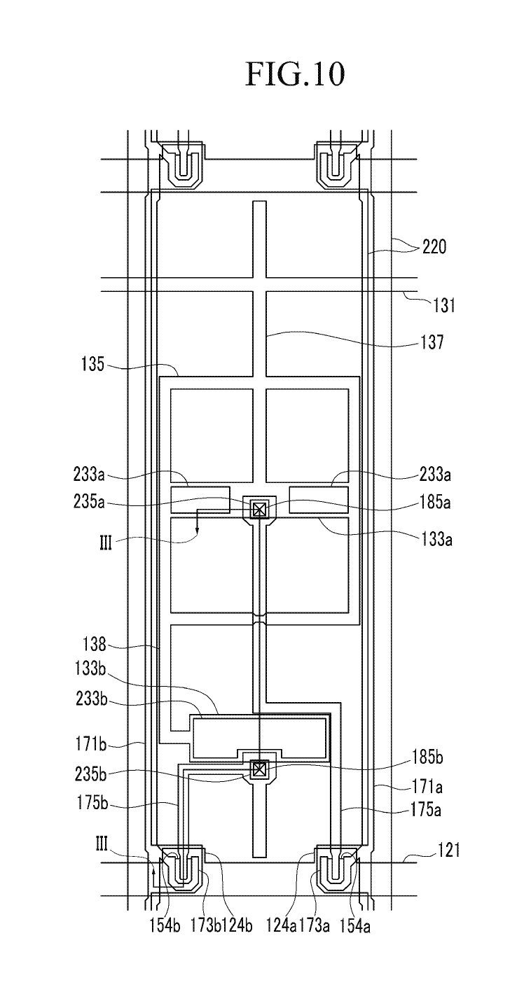

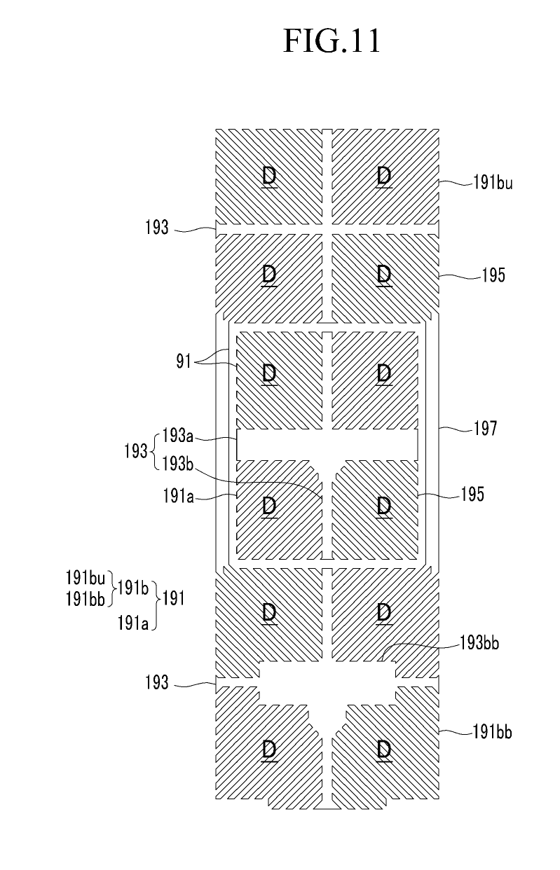

FIG. 8 is a layout view of an exemplary LCD according to an exemplary embodiment of the present invention, FIG. 9 is a cross-sectional view taken along line IX-IX of FIG. 8, FIG. 10 is a layout view of the exemplary LCD shown in FIG. 8 except for the pixel electrode, and FIG. 11 is a layout view of the exemplary pixel electrode in the exemplary LCD shown in FIG. 8.

Referring to FIG. 8 to 11, a plurality of gate lines 121 and a plurality of storage electrode lines are disposed on an insulating substrate 110.

The gate lines 121 transmit gate signals and extend in a transverse direction, the first direction. Each gate line 121 includes a plurality of first and second gate electrodes 124a and 124b protruding upward.

The storage electrode lines include a stem 131 extending substantially parallel to the gate lines 121, and a plurality of branches extended from the stem 131. Each branch includes a longitudinal portion 137, 138, a hook-shaped portion 135, a first storage electrode 133a, and a second storage electrode 133b.

The longitudinal portion 137 is extended upward and downward in the second direction from the stem 131 (hereinafter, an imaginary straight line of the direction that the longitudinal portion 137 is extended is referred as a “longitudinal central line”). The longitudinal portion 138 is extended downward from left or right of the stem 131, and may extend downward from the hook-shaped portion 135.

The hook-shaped portion 135 is almost rectangular, and the upper edge thereof vertically meets the longitudinal portion 137.

The first storage electrode 133a is extended in a transverse direction from a central portion of the left edge of the hook-shaped portion 135 to a central portion of the right edge of the hook-shaped portion 135, and has a wider width than the longitudinal portion 137 or the hook-shaped portion 135. The first storage electrode 133a and the longitudinal portion 137 vertically meet each other, as shown in FIG. 10, with the longitudinal portion 137 crossing the area defined by the hook-shaped portion 135 to meet the first storage electrode 133a.

The left edge of the hook-shaped portion 135 is extended downward to form longitudinal portion 138 and is curved in the right direction to form the second storage electrode 133b. The width of the second storage electrode 133b is expanded, as compared to a width of the longitudinal portion 138 or hook-shaped portion 135, and is extended substantially parallel to the first storage electrode 133a in the transverse direction.

However, the shapes and arrangement of the storage electrode lines 131, 133a, 133b, 135, 137, and 138 may be modified in various forms.

A gate insulating layer 140 is disposed on the gate lines 121 and the storage electrode lines 131, 133a, 133b, 135, 137, and 138, and a plurality of semiconductors 154a and 154b preferably made of amorphous or crystallized silicon are disposed on the gate insulating layer 140.

A pair of ohmic contacts 163b and 165b are disposed on the second semiconductor 154b, and a pair of data lines 171a and 171b and a plurality of first and second drain electrodes 175a and 175b are disposed on the ohmic contacts 163b and 165b, and on the gate insulating layer 140. Although not shown, a pair of ohmic contacts may also be disposed on the first semiconductor 154a.

The data lines 171a and 171b transmit data signals, extend substantially in the longitudinal direction, the second direction, and cross the gate lines 121 and the stem 131 of the storage electrode lines. Each data line 171a/171b includes a plurality of first/second source electrodes 173a/173b extending toward the first/second gate electrodes 124a/124b and may be curved with a “U” shape, and the first/second source electrodes 173a/173b are opposite to the first/second drain electrodes 175a/175b with respect to the first/second gate electrodes 124a/124b.

In an exemplary embodiment, each first drain electrode 175a starts from one end enclosed by the first source electrode 173a, extends upward, curves in the left direction according to the upper edge of the second storage electrode 133b, and again extends upward near the longitudinal central line to form the other end of the first drain electrode 175a. The other end of the first drain electrode 175a is extended to where the first storage electrode 133a is disposed, and has a wide area for connection with another layer.

Each second drain electrode 175b starts from one end enclosed by the second source electrode 173b, extends upward to the second storage electrode 133b, curves in the right direction, extends according to the lower edge of the second storage electrode 133b, expands with a wide area near the longitudinal central line, and again extends downward.

While a particular arrangement has been shown and described, the shapes and arrangement of the first and second drain electrodes 175a and 175b and the data lines 171a and 171b may be modified in various forms.

A first/second gate electrode 124a/124b, a first/second source electrode 173a/173b, and a first/second drain electrode 175a/175b respectively form a first/second TFT along with a first/second semiconductor 154a/154b, and a channel of the first/second TFT is formed on the first/second semiconductor 154a/154b between the first/second source electrode 173a/173b and the first/second drain electrode 175a/175b.

A lower passivation layer 180p preferably made of silicon nitride or silicon oxide is disposed on the data lines 171a and 171b, the drain electrodes 175a and 175b, and the exposed portions of the semiconductors 154a and 154b.

Light blocking members 220 may be disposed on the lower passivation layer 180p in a region of the first/second TFTs and along the first/second data lines 171a/171b, the gate lines 121, etc. A plurality of color filters 230 are disposed on the lower passivation layer 180p. The color filters 230 are mostly formed in a region surrounded by the light blocking members 220. The color filters 230 have a plurality of holes 235a and 235b disposed on the first and second drain electrodes 175a and 175b, and a plurality of openings 233a and 233b disposed on the first and second storage electrodes 133a and 133b. The openings 233a and 233b reduce the thickness of the dielectric material forming the storage capacitors Csta and Cstb such that the storage capacitance may be increased.

Here, the lower passivation layer 180p may prevent the pigments of the color filter 230 from flowing into the exposed semiconductors 154a and 154b.

An upper passivation layer 180q is disposed on the color filters 230. The upper passivation layer 180q may be made of an inorganic insulating material such as silicon nitride or silicon oxide, and prevents the color filters 230 from lifting and suppresses the contamination of the liquid crystal layer 3 by an organic material such as a solvent flowing from the color filters 230 such that defects such as an afterimage that may be generated during driving may be prevented.

The upper passivation layer 180q includes protrusions 800 as in the first exemplary embodiment, and the protrusions 800 may be formed into one body with the upper passivation layer 180q, or may be provided as an additional layer.

In an alternative exemplary embodiment, at least one of the light blocking members 220 and the color filters 230 may be disposed on the upper panel 200 as in the first embodiment, and one of the lower passivation layer 180p and the upper passivation layer 180q of the lower panel 100 may be omitted in this case.

When the upper passivation layer 180q is not formed, the protrusions 800 may be formed by using the color filters 230.

The upper passivation layer 180q and the lower passivation layer 180p have a plurality of contact holes 185a and 185b respectively exposing the first and second drain electrodes 175a and 175b.

A plurality of pixel electrodes 191 are disposed on the upper passivation layer 180q, and the above-described color filters 230 may be extended according to a column of the pixel electrodes 191.

Referring to FIG. 8, and with further reference to FIG. 11, each pixel electrode 191 includes the first and second subpixel electrodes 191a and 191b that are separated from each other with a gap 91 of a quadrangular belt shape therebetween. The first and second subpixel electrodes 191a and 191b are respectively included in a basic electrode with pixel electrode 191 as shown in FIG. 1, or at least one modification thereof. Hereafter, pixel electrode 191 shown in FIG. 1 will be the basic electrode for convenience

Again, referring to FIG. 8 and FIG. 9, as well as FIG. 11, the first subpixel electrode 191a includes one basic electrode. The transverse stem 193 of the basic electrode forming the first subpixel electrode 191a expands downward and upward to form a first expansion 193a, and the first expansion 193a overlaps the first storage electrode 133a. Also, the protrusion that protrudes downward for easy contact with the first drain electrode 175a is formed in the center of the downward edge of the first expansion 193a. A longitudinal portion 193b may extend downwardly and upwardly from the first expansion 193a such that the first sub pixel electrode 191a is substantially divided into four quadrants.

The second subpixel electrode 191b includes an upper electrode 191bu and a lower electrode 191bb, and the upper electrode 191bu and the lower electrode 191bb respectively include one basic electrode. The upper electrode 191bu and the lower electrode 191bb are connected to each other through two left and right connections 197.

The second subpixel electrode 191b encloses the first subpixel electrode 191a with the gap 91 interposed therebetween. A portion of the center of the transverse stem 193 of the lower electrode 191bb extends upward and downward to form a second expansion 193bb overlapping the second storage electrode 133b. Also, the protrusion that protrudes downward for easy contact with the second drain electrode 175b is formed in the center of the downward edge of the second expansion 193bb. Longitudinal portions may extend upwardly and downwardly from the transverse stems 193 in the upper electrode 191bu and lower electrode 191bb such that each of the upper electrode 191bu and lower electrode 191bb are substantially divided into four quadrants.

The area of the second subpixel electrode 191b may be about 1.0 to about 2.2 times the area of the first subpixel electrode 191a.

The end portions of the minute branches 195 disposed on the sub-regions D and the stem 193 are protruded towards the upper panel 200 by the protrusions 800 provided thereunder as compared with other portions of the minute branches 195 that do not overlap protrusions 800.

Each first/second subpixel electrode 191a/191b is physically and electrically connected to the first/second drain electrode 175a/175b through the contact hole 185a/185b.

An alignment layer 11 is disposed on the pixel electrode 191.

Next, the upper panel 200 will be described.

A common electrode 270 is disposed on an insulating substrate 210, and an alignment layer 21 is disposed thereon. Each of the alignment layers 11 and 21 may be a vertical alignment layer.

Finally, polarizers (not shown) may be provided on the outer surface of the display panels 100 and 200.

The first/second subpixel electrode 191a/191b and the common electrode 270 form the liquid crystal capacitor to maintain an applied voltage even after the TFT is turned off. Also, the first and second storage electrodes 133a and 133b of the storage electrode line 131 respectively overlap with the first and second subpixel electrodes 191a and 191b in the openings 188a and 188b to form the storage capacitors Csta and Cstb.

The hook-shaped portion 135 of the storage electrode line 131 overlaps the gap 91 of the pixel electrode 191 such that it functions as a shielding member for blocking light leakage between the first subpixel electrode 191a and the second subpixel electrode 191b. The hook-shaped portion 135 disposed between the data lines 171a and 171b, and the first subpixel electrode 191a, prevents crosstalk to thereby reduce degradation of display quality.

The first subpixel electrode 191a and the second subpixel electrode 191b may be applied with different data voltages through the different data lines 171a and 171b, and the voltage of the first subpixel electrode 191a having the relatively small area may be higher than the voltage of the second subpixel electrode 191b having the relatively large area.

In this way, if the voltages of the first subpixel electrode 191a and the second subpixel electrode 191b are different from each other, the voltage applied to the first liquid crystal capacitor Clca formed between the first subpixel electrode 191a and the common electrode 270 and the voltage applied to the second liquid crystal capacitor Clcb formed between the second subpixel electrode 191b and the common electrode 270 are different from each other such that the declination angle of the liquid crystal molecules 31 of the subpixels PXa and PXb are different from each other, and as a result the luminance of the two subpixels PXa and PXb become different. Accordingly, if the voltages of the first and second liquid crystal capacitors Clca and Clcb are appropriately controlled, the images shown at the side may be approximate to the image shown at the front, that is to say, the gamma curve of the side may be approximately close to the gamma curve of the front, thereby improving the side visibility.

### Fourth Exemplary Embodiment

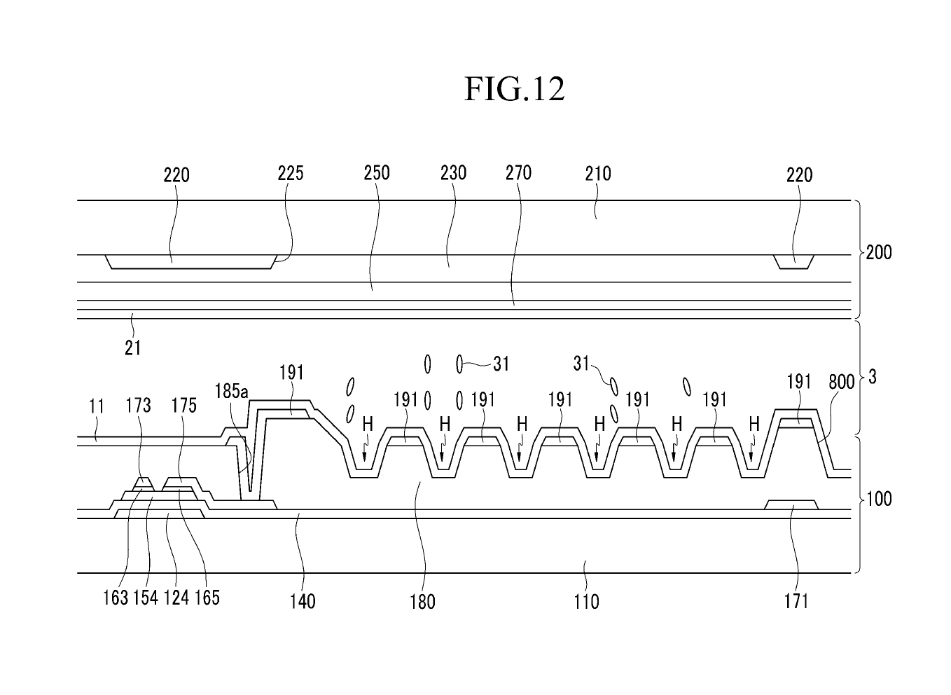

FIG. 12 is a cross-sectional view of an exemplary LCD according to another exemplary embodiment of the present invention, taken along line II-II of FIG. 1.

The layered structure of the LCD according to the present exemplary embodiment and the descriptions thereof are substantially the same as those of the previous exemplary embodiment shown in FIG. 1 to FIG. 3, so descriptions of the same elements are omitted and only different elements from those of the previous exemplary embodiment will be described in the current exemplary embodiment of the present invention. The upper panel 200 is the same as the upper panel 200 shown in FIG. 2, such that only the lower panel 100 will be described.

In the lower panel 100 of FIG. 12, a gate line having a gate electrode 124 is disposed on a substrate 110, and a gate insulating layer 140 is disposed on the gate electrode 124. A semiconductor 154 and ohmic contacts 163 and 165 are disposed on the gate insulating layer 140, and a data line 171 having a source electrode 173 overlapping the ohmic contacts 163 and 165, and a drain electrode 175 are disposed on the semiconductor 154, the ohmic contacts 163 and 165, and the gate insulating layer 140.

A passivation layer 180 is disposed on the data line 171 and the drain electrode 175, and a pixel electrode 191 and an alignment layer 11 are disposed on the passivation layer 180.

However, the passivation layer 180 shown in FIG. 12 includes grooves H at which the passivation layer 180 between the minute branches 195 is removed according to the minute branches 195. Here, the depth of the grooves H is less than about 1/10 of the cell gap, and the depth of the grooves may be about 0.5 μm.

In an exemplary embodiment, the grooves H may be formed when forming the contact holes 185a. In an alternative exemplary embodiment, the grooves H may be formed by etching the passivation layer 180 by using the pixel electrode 191 or the photosensitive pattern for the pixel electrode 191 as a mask after forming the pixel electrode 191.

A portion of the passivation layer 180 overlapping the data line 171 may be protruded from another portion of the data line 171.

The liquid crystal molecules 31 are pre-tilted according to the grooves H through the whole substrate, thereby increasing the response speed of the liquid crystal molecules 31.

Also, the LCD of FIG. 12 may include the protrusions of the upper panel like the second exemplary embodiment shown in FIG. 7. In an alternative exemplary embodiment, the upper panel 200 may also include grooves, such as grooves within the overcoat 250, and the protrusion may be formed according to the grooves.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first substrate and a second substrate facing each other;
a plurality of pixel electrodes arranged in a matrix shape on the first substrate and each including a stem and a plurality of minute branches obliquely extending from the stem;
a common electrode facing the plurality of pixel electrodes; and
a liquid crystal layer interposed between the first substrate and the second substrate and including a plurality of liquid crystal molecules,
wherein the pixel electrodes are classified into a plurality of sub-regions according to a length direction of the minute branches, and the minute branches are protruded at edges of the sub-regions.

2. The liquid crystal display of claim 1, further comprising
a passivation layer disposed between the first substrate and the pixel electrodes,
wherein the passivation layer includes a first protrusion corresponding to the edges of the sub-regions.

3. The liquid crystal display of claim 2, wherein
one end of the minute branches overlaps the first protrusion.

4. The liquid crystal display of claim 3, wherein
the passivation layer is made of an organic material having a low dielectric ratio.

5. The liquid crystal display of claim 4, further comprising:
a gate line disposed on the first substrate and disposed under the pixel electrode;
a data line intersecting the gate line; and
a thin film transistor connected to the gate line, the data line, and the pixel electrode,
wherein the one end of the minute branches overlaps the data line.

6. The liquid crystal display of claim 3, wherein
the stem connected to the minute branches overlaps the first protrusion.

7. The liquid crystal display of claim 2, wherein
a thickness of the first protrusion is less than about 1/10 of a cell gap between an upper layer having the second substrate and a lower layer having the first substrate.

8. The liquid crystal display of claim 7, wherein
the thickness of the first protrusion is substantially 0.5 μm.

9. The liquid crystal display of claim 2, wherein
a cross-section of the first protrusion is trapezoidal.

10. The liquid crystal display of claim 9, wherein:
liquid crystal molecules close to the first protrusion among liquid crystal molecules of the liquid crystal layer are perpendicular to a side surface of the first protrusion.

11. The liquid crystal display of claim 10, wherein
liquid crystal molecules corresponding to a central region of the minute branches among the liquid crystal molecules of the liquid crystal layer are perpendicular to the first substrate.

12. The liquid crystal display of claim 2, further comprising
an overcoat disposed between the common electrode and the second substrate,
wherein the overcoat includes a second protrusion corresponding to an area between first protrusions.

13. The liquid crystal display of claim 12, wherein
the common electrode forms a convexo-concave surface according to the second protrusion.

14. The liquid crystal display of claim 13, wherein
a thickness of the second protrusion is less than about 1/10 of a cell gap between an upper layer having the second substrate and a lower layer having the first substrate.

15. The liquid crystal display of claim 14, wherein
the thickness of the second protrusion is less than about 0.5 μm.

16. The liquid crystal display of claim 12, wherein
a cross-section of the second protrusion is trapezoidal.

17. The liquid crystal display of claim 1, wherein
the minute branches of neighboring sub-regions are symmetrical with respect to the stem of the sub-regions.

18. The liquid crystal display of claim 17, wherein
the minute branches of two neighboring sub-regions are orthogonal to each other.

19. The liquid crystal display of claim 1, wherein the minute branches protrude towards the second substrate at the edges of the sub-regions.

20. The liquid crystal display of claim 1, wherein a layer of the liquid crystal display including the pixel electrodes has a substantially constant thickness.

21. A liquid crystal display comprising:
a first substrate and a second substrate facing each other;
a plurality of pixel electrodes arranged in a matrix shape on the first substrate and including a stem and a plurality of minute branches obliquely extending from the stem;
a common electrode facing the plurality of pixel electrodes; and
a liquid crystal layer interposed between the first substrate and the second substrate and including a plurality of liquid crystal molecules,
wherein the pixel electrodes are classified into a plurality of sub-regions according to a length direction of the minute branches, and a first groove is disposed according to the length direction of the minute branches between the minute branches.

22. The liquid crystal display of claim 21, further comprising
a passivation layer disposed between the first substrate and the pixel electrodes,
wherein the first groove is formed in the passivation layer.

23. The liquid crystal display of claim 22, further comprising
an overcoat disposed between the common electrode and the second substrate,
wherein the overcoat includes a second groove corresponding to an area between first grooves.

24. The liquid crystal display of claim 22, wherein
the passivation layer is made of an organic material having a low dielectric ratio.

25. The liquid crystal display of claim 22, wherein
a depth of the groove is less than about 1/10 of a cell gap between an upper layer having the second substrate and a lower layer having the first substrate.

26. The liquid crystal display of claim 25, wherein
the depth of the groove is substantially 0.5 μm.

27. A method of improving response speed of a liquid crystal display, the method comprising:
arranging a plurality of pixel electrodes in a matrix shape on a first substrate of the liquid crystal display, each pixel electrode including a stem and a plurality of minute branches obliquely extending from the stem, the pixel electrodes classified into a plurality of sub-regions according to a length direction of the minute branches;
interposing a liquid crystal layer between the first substrate and a second substrate of the liquid crystal display; and,
protruding the minute branches at edges of the sub-regions towards the second substrate.
